(19) United States
(12) Patent Application Publication
(10) Pub. No.: US 2013/0133024 A1
(43) Pub. Date: May 23, 2013

(54) Auto-Approval of Recovery Actions Based on an Extensible Set of Conditions and Policies

(71) Applicants: Alexander MacLeod, Seattle, WA (US); Andrey Lukyanov, Redmond, WA (US); Pretish Abraham, Sammamish, WA (US); Rajmohan Rajagopalan, Redmond, WA (US); Shane Brady, Seattle, WA (US)

(72) Inventors: Alexander MacLeod, Seattle, WA (US); Andrey Lukyanov, Redmond, WA (US); Pretish Abraham, Sammamish, WA (US); Rajmohan Rajagopalan, Redmond, WA (US); Shane Brady, Seattle, WA (US)

(73) Assignee: MICROSOFT CORPORATION, Redmond, WA (US)

(21) Appl. No.: 13/301,872

(22) Filed: Nov. 22, 2011

(51) Int. Cl. G06F 21/00

(52) U.S. Cl. 726/1

(57) ABSTRACT

Recovery action approval may be provided. A request to perform an action may be received from a user. If the user is not always authorized to request the action, then the action may be performed if a policy rule permits the user to request the action.

### RELATED APPLICATION

Related U.S. patent application Ser. No. ______, filed on even date herewith entitled “Superseding of Recovery Actions Based on Aggregation of Requests for Automated Sequencing and Cancellation,” assigned to the assignee of the present application, is hereby incorporated by reference.

### BACKGROUND

Approval of recovery actions in a hosted environment may be provided. Hosted computed environments, such as datacenters, rely on automation to provide high level of service availability and customer data security. However, in some cases manual actions by designated support users are required to restore service availability. Often the user is required to execute a sequence of related commands to resolve the issue. It is important to protect hosted service environment from possible errors in manual user actions or intentional misconduct. Conventional solutions require setting up a granular permission model in the hosted environment wherein support users are delegated with a minimal set of permissions to perform their routine tasks. In the event they need to execute a command that can potentially compromise service availability or customer data security, they have to follow a designated approval process, where commands to be executed must be submitted to high privilege expert decision makers (approvers).

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Recovery action approval may be provided. A request to perform an action may be received from a user. If the user is not always authorized to request the action, then the action may be performed if a policy rule permits the user to request the action.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing recovery action approval; and

FIG. 3 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Automated recovery actions may be requested by users who are not permitted to run certain operations. Based on an approval policy, certain recovery actions may be added to a list of auto-approved recovery actions. An extensible set of conditions to this permission model may comprise, for example, service incidents in the hosted environment, a number of iterations, a valid until X time, and valid until revoked, etc. For example, when a domain name system (DNS) service outage occurs, an approval policy may automatically allow users who would not normally be permitted to start, restart and/or stop the DNS service to issue those commands in order to restore the service. By providing this framework, customer's data may be protected from unnecessary exposure and incident recovery time may be reduced.

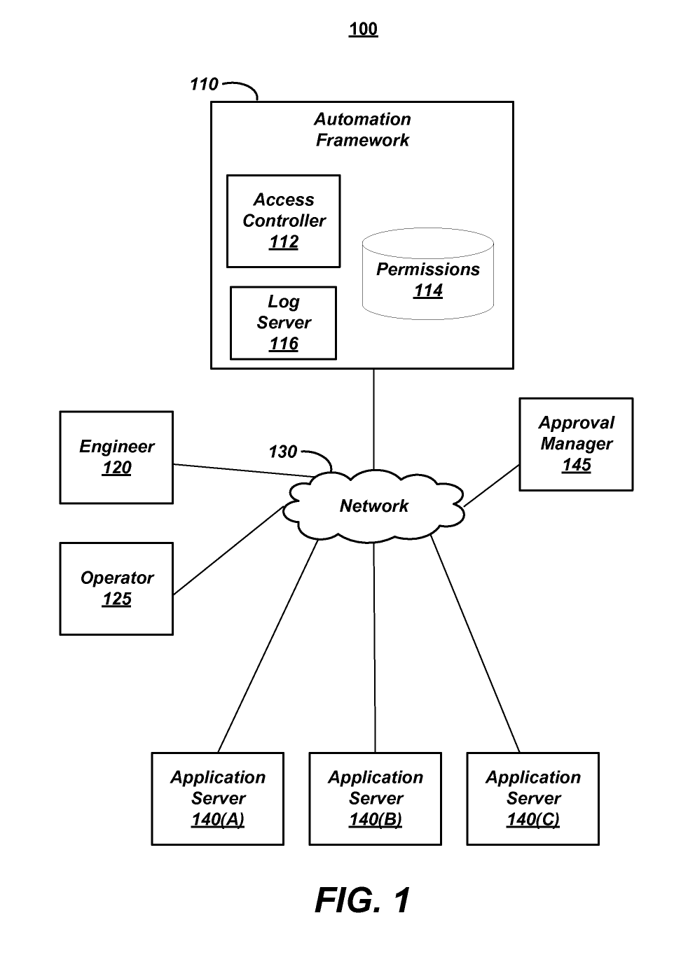

FIG. 1 is a block diagram of an operating environment 100 comprising an automation framework 110. Automation framework 110 may comprise an access controller 112, a permissions database 114, and a log server 116. Automation framework 110 may receive action requests from an engineer 120 and/or an operator 125 via a network 130. Action requests may be evaluated by access controller 112 against permissions database 114 that may comprise “always available” security rights and/or policy rules controlling temporary rights for users. The result of requesting and/or performing the action may be reported to log server 116. If the user is determined to have permanent or temporary rights to perform the requested action, the action may be performed on one or more of a plurality of application servers 140(A)-(C). Otherwise, the request may be forwarded to an approval manager 145 for evaluation.

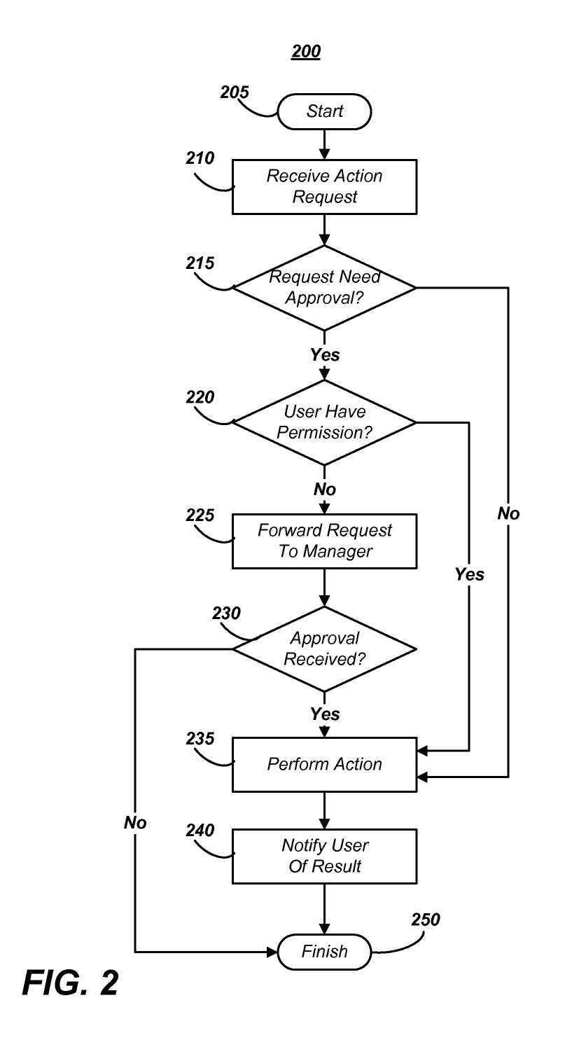

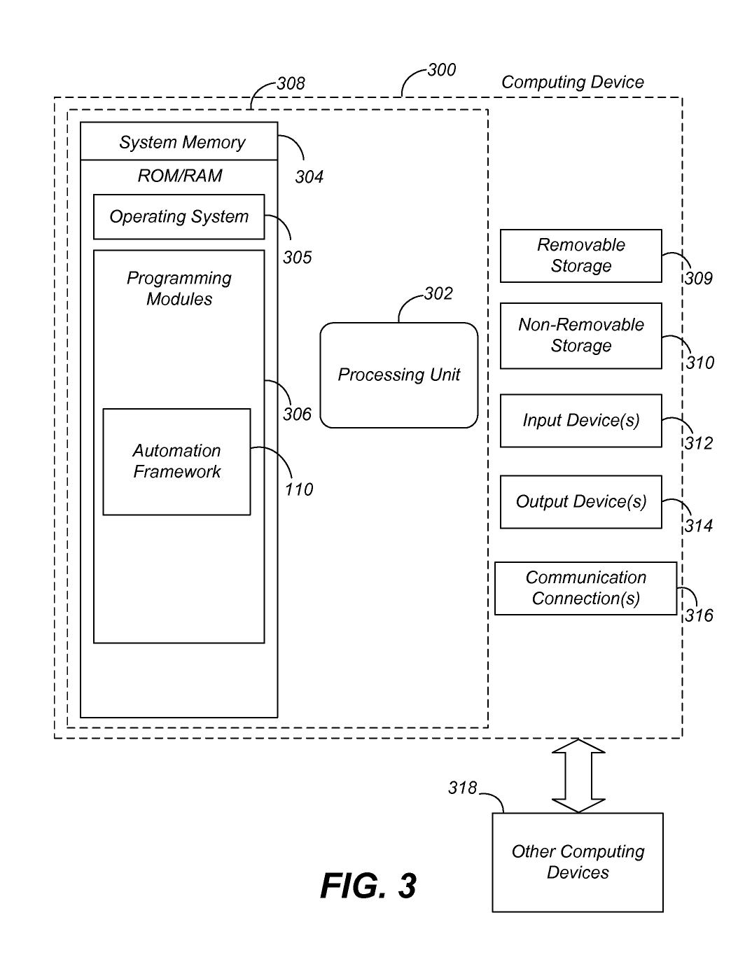

FIG. 2 is a flow chart setting forth the general stages involved in a method 200 consistent with an embodiment of the invention for providing recovery action approval. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may receive a request to perform an action from a user. For example, operator 125 may submit a request to restart a service on application server 140(A). Such actions may, for example, be associated with remedying a service incident such as a crashed or hung service.

Method 200 may then advance to stage 215 where computing device 300 may determine whether the requested action requires approval. For example, read-only actions such as log queries may be performed with a lower level of permissions than production-affecting actions, such as a service restart.

In response to determining that the requested action requires approval, method 200 may advance to stage 220 where computing device 300 may determine whether the user has permission to request the action. Such permission may be temporary, such as where a policy rule comprising a grant condition, at least one permission grant, and an expiration condition gives the user permission to request the action, and/or may comprise a permanent permission right assigned to the user. Automation framework 110 may implement a permission scheme that assigns permissions to users based on an access level, ownership of a resource, and/or membership in a static or dynamic user group. For example, operator 125 may belong to a dynamic user group of on-call technicians that may have different permission access while they are on duty than when they are off duty. Approval manager 145 may belong to a static user group of administrators that have permanently higher permissions than engineer 120 and/or operator 125.

The policy rule may grant permission to the user to perform the action when a grant condition, such as an ownership or service incident condition is satisfied. For example, if the user owns the resource on which they are requesting the action be performed, the user may be granted a permission to which they would normally not be entitled. The rule may further comprise an expiration condition that gives the user permission to continue requesting the action until the expiration condition is met. For example, the expiration condition may comprise a time limit (e.g., one hour), an iteration limit (e.g., permission to request the action five times), and/or may grant the user permission to request the action until the permission is revoked, such as through explicit action by an administrator and/or by the user leaving a dynamic user group.

In response to determining that the user does not have temporary permission to request the action, method 200 may advance to stage 225 where computing device 300 may forward the action request to an approval manager. For example, automation framework 110 may forward details of the requested action to approval manager 145 via email.

Method 200 may then advance to stage 230 where computing device 300 may determine whether approval to perform the action has been received. For example, approval manager 145 may approve the requested action and submit the approval via email and/or a web form to automation framework 110.

If the request is determined not to need approval at stage 215, if the user was determined to have permission at stage 220, and/or after approval was received at stage 230, method 200 may advance to stage 235 where computing device 300 may perform the requested action. For example, automation framework 110 may issue a restart command to a service on application server 140(A).

Method 200 may then advance to stage 240 where computing device 300 may notify the requesting user of a result. For example, the user may be notified as to whether a requested restart action succeeded or failed. Method 200 may then end at stage 250.

An embodiment consistent with the invention may comprise a system for providing recovery action approval. The system may comprise a memory storage and a processing unit coupled to the memory storage. The processing unit may be operative to receive a request to perform an action from a user, determine whether the user is always authorized to request the action and, in response to determining that the user is not always authorized to request the action, determine whether a policy rule permits the user to request the action. In response to determining that the policy rule permits the user to request the action, the processing unit may be operative to perform the action.

Another embodiment consistent with the invention may comprise a system for providing recovery action approval. The system may comprise a memory storage and a processing unit coupled to the memory storage. The processing unit may be operative to receive a request to perform an action from a user, determine whether a condition associated with a policy rule is satisfied, wherein the policy rule is operative to control permission to perform the action and, in response to determining that the condition associated with the policy rule is satisfied, perform the action. In response to determining that the condition associated with the policy rule is not satisfied, the processing unit may be operative to forward the request to an approval manager.

Yet another embodiment consistent with the invention may comprise a system for providing recovery action approval. The system may comprise a memory storage and a processing unit coupled to the memory storage. The processing unit may be operative to receive a request to perform an action from a user, wherein the action is associated with remedying a service incident, determining whether the requested action requires approval and, in response to determining that the requested action requires approval, determine whether the user has temporary permission to request the action. In response to determining that the user does not have temporary permission to request the action, the processing unit may be operative to forward the action request to an approval manager. In response to determining that the user has temporary permission to request the action, the processing unit may be operative to perform the action and notify the user of a result of performing the action.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIG. 3 and the associated descriptions provide a discussion of a variety of operating environments in which embodiments of the invention may be practiced. However, the devices and systems illustrated and discussed with respect to FIG. 3 are for purposes of example and illustration and are not limiting of a vast number of computing device configurations that may be utilized for practicing embodiments of the invention, described herein.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise operating environment 300 as described above. Methods described in this specification may operate in other environments and are not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include automation framework 110. Operating system 305, for example, may be suitable for controlling computing device 300's operation. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, a capture device, etc. A capture device may be operative to record a user and capture spoken words, motions and/or gestures made by the user, such as with a camera and/or microphone. The capture device may comprise any speech and/or motion detection device capable of detecting the speech and/or actions of the user. For example, the capture device may comprise a Microsoft® Kinect® motion capture device comprising a plurality of cameras and a plurality of microphones. Output device(s) 314 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 304, including operating system 305. While executing on processing unit 302, programming modules 306 may perform processes and/or methods as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the invention may be practiced via a system-on-a-chip (SOC) where each and/or many of the components illustrated above may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with any component of operating environment 100 may operate via application-specific logic integrated with other components of the computing device/system on the single integrated circuit (chip).

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicants. The Applicants retain and reserve all rights in the code included herein, and grant permission to reproduce the material only in connection with reproduction of the granted patent and for no other purpose.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing recovery action approval, the method comprising:
receiving a request to perform an action from a user;
determining whether the user is always authorized to request the action;
in response to determining that the user is not always authorized to request the action, determining whether a policy rule permits the user to request the action; and
in response to determining that the policy rule permits the user to request the action, performing the action.

2. The method of claim 1, wherein the policy rule comprises a condition, an expiration condition, and at least one action permission.

3. The method of claim 2, wherein the policy rule grants the at least one action permission to a plurality of users when the condition is satisfied.

4. The method of claim 2, wherein the condition comprises an ownership condition.

5. The method of claim 2, wherein the condition comprises a service incident condition.

6. The method of claim 1, wherein the policy rule comprises an expiration condition.

7. The method of claim 6, wherein the expiration condition comprises a time limit.

8. The method of claim 6, wherein the expiration condition comprises an iteration limit.

9. The method of claim 1, wherein the policy rule permits the user to request the action until the permission is revoked.

10. The method of claim 1, wherein the policy rule permits the user to request the action as long as the user is associated with a dynamic user group.

11. A system for providing recovery action approval, the system comprising:
a memory storage; and
a processing unit coupled to the memory storage, wherein the processing unit is operable to:
receive a request to perform an action from a user,
determine whether a condition associated with a policy rule is satisfied, wherein the policy rule is operative to control permission to perform the action,
in response to determining that the condition associated with the policy rule is satisfied, perform the action, and
in response to determining that the condition associated with the policy rule is not satisfied, forward the request to an approval manager.

12. The system of claim 11, wherein the action is associated with remedying a service outage.

13. The system of claim 11, wherein the condition comprises membership of the user in a dynamic user group.

14. The system of claim 13, wherein the dynamic user group comprises a plurality of on call service users.

15. The system of claim 11, wherein the condition comprises one of a plurality of dependent conditions.

16. The system of claim 15, wherein at least one first condition of the plurality of dependent conditions comprises an outage of at least one application service.

17. The system of claim 16, wherein at least one second condition of the plurality of dependent conditions comprises an ownership of the at least one application service by the user.

18. The system of claim 11, wherein the processing unit is further operative to grant the user permission to perform the action until an expiration condition is met.

19. The system of claim 11, wherein the processing unit is further operative to notify the user of a result of performing the action.

20. A computer-readable medium which stores a set of instructions which when executed performs a method for providing recovery action approval, the method executed by the set of instructions comprising:
receiving a request to perform an action from a user, wherein the action is associated with remedying a service incident;
determining whether the requested action requires approval, wherein determining whether the requested action requires approval comprises determining whether a permission scheme does not grant the user permanent rights to request the action;
in response to determining that the requested action requires approval, determining whether the user has temporary permission to request the action, wherein determining whether the user has permission to request the action comprises determining whether at least one policy rule is applicable, wherein the at least one policy rule comprises a grant condition, at least one permission grant, and an expiration condition;
in response to determining that the user does not have temporary permission to request the action, forwarding the action request to an approval manager; and
in response to determining that the user has temporary permission to request the action:
performing the action, and
notifying the user of a result of performing the action.
